(19) United States
(12) Patent Application Publication
(10) Pub. No.: US 2007/0089577 A1
(43) Pub. Date: Apr. 26, 2007

(54) Mandolin food slicer adjustment method and apparatus

(76) Inventor: Vincent Wong, Bellevue, WA (US)

Correspondence Address: HUGHES LAW FIRM, PLLC, PACIFIC MERIDIAN PLAZA, SUITE 302, 4164 MERIDIAN STREET, BELLINGHAM, WA, 98226-5583, US

(21) Appl. No.: 11/256,458

(22) Filed: Oct. 21, 2005

(51) Int. Cl. B26D 1/00

(52) U.S. Cl. 83/13

(57) ABSTRACT

A food slicer to slice food items in variable widths or thicknesses, the slicer has a frame with an upper and lower platform guide plate to slice food. It also has a translational guide system which moves the top guide plate within a parallel plane between the longitudinally aligned side rails. The translational guide system takes on many forms. One form is a rack and pinion system where the rack is attached to the top guide plate and the pinion is attached to one of two transversely aligned axles. The axles allow for range of movement of the guide plate between an upper location and a lower location. By adjusting the translational guide system, the top guide plate can move up and down between the upper and lower limits or locations which creates differing widths of the cutting slot. The top guide plate has a removable julienne blade plate portion. The bottom guide plate has a removable horizontal blade portion. Moving the food up and down the guide plates passes the food items over the julienne blades and the horizontal blade and cuts the food item which drops through the cutting slot.

### BACKGROUND

a) Field

The present invention relates to products which are particularly adapted for preparing food for use in the culinary arts. Many times the chef or food preparer will utilize a food slicer or what is more commonly known in the industry as a mandolin, to prepare large quantities of fresh food. Such food could be for instance, sliced potatoes for creating French fries or sliced and shredded carrots as a garnishment. Often times, the adjustments to these mandolins do not enable the user to adequately adjust the cutting thickness to the desired height or width of the finished prepared food.

b) Background Art

U.S. patent publication number U.S. Pat. No. 2004/0216579 published on Nov. 4, 2004, discloses a food slicer which has a frame with a food receiving platform and an aperture. A reversible cutting blade has first and second cutting edges and can be selectively removed from the mounting frame in first and second positions for disposing the first and second cutting edges in the aperture for engagement with food being moved along the platform. The slicer has support legs which are rotatably carried by the frame and can be rotated and moved to a stowed position.

U.S. Pat. No. 379,745 design patent, discloses a slicer which seems to have rotatable vertical blades, with a fixed food slicing plate, the vertical blades rise through a series of fixed longitudinal slots, the spacing of the slots correspond to the horizontal spacing of the vertical blades. Also, a fixed horizontal cutting blade seems to be provided.

U.S. Pat. No. 4,038,892 discloses a food slicer with an indexing turret, the turret has four faces, two of which have upstanding blades of different sizes on opposed faces, and two faces have different offset relationship to the centerline of the turret. Referred to Col 3 at line 52, the food slicer contemplates a base, a body portion, the body portion having two sides and terminating at side guide rails. A blade is at the end portion of the table blade segment and is angled at a 45 degree angle to the body sides. The table blade can be positioned into two locations, an upper way, or a lower way. Further, an indexing turret as referred to in Col 5 at line 59 provides large French fry blades. In the opposite side of the indexing turret a plurality of parallel shoestring blades are provided. The blades are positioned parallel with the longitudinal axis of the table. The horizontal cutting blade moves vertically up-and-down to provide the thickness variation for the food slices, and the indexing turret provides the rotational engagement for the varying cutting widths.

U.S. Pat. No. 2,766,793 discloses a vegetable slicer having an adjustable cutting member, referring to Col. 1 at line 57, a board is provided which is substantially rectangular, and has a handle at one end and a rectangular opening at the other end. On the upper surface of the board is a plate preferably made of metal. The front edge of the plate is transverse in relation to the board and disposed nearest to the handle is a sharpened defined knife. Adjacent to the upper surface of the board is provided a recess for accommodating the edge of a plate. The device also has a pair of rack bars positioned in an oblique transverse relation to the board. Transverse to the board in an edge to edge relationship is a bore made in the board, and a shaft is positioned centrally there. The shaft has a pair of gears, one adjacent to each side of the board. The teeth are in a mesh with each rack bar. The gears are also in further relationship with a shaft. The shaft can be permitted to rotate the gears by manipulating the knob in either direction. This will shift the rack bars in a transverse relation to the board for raising and lowering of the knife edge with relation to the upper surface of the board. Thus, the gears provide the means through which the board can be raised and lowered.

U.S. Pat. No. 144,596 discloses a device for slicing or cutting vegetables with a knife readily removed from a rectangular frame. The knife is arranged diagonally within the rectangular frame having at its rear end portions hooks or arms which are adapted to the frame and provided vertical adjustment means.

U.S. Pat No. 66,402 discloses a vegetable cutter which consists of a plate having a stationary knife attached to it, the stationary knife in combination with a plate can be adjusted to regulate the thickness of the slices of the vegetables cut from the plate. A set screw is utilized to raise and lower the cutting plate.

### BRIEF DESCRIPTION OF THE DRAWINGS

FIG. 1 is a perspective view of the food slicer;

FIG. 2 is a perspective view of the blade cutting assembly;

FIG. 2A is an exploded view of the removable upper glide plate with a flat glide plane;

FIG. 2B is an exploded view of the removable upper glide plate with small vertical julienne blades;

FIG. 2C is an exploded view of the removable upper glide plate with large vertical julienne blades;

FIG. 2D is an exploded view of the removable lower glide plate with a straight edge horizontal slicing blade;

FIG. 2E is an exploded view of the removable lower glide plate with wave form horizontal slicing blade;

FIG. 3 is a perspective view of the food slicer frame and nonremovable upper glide plate;

FIG. 4 is a detail perspective view of the upper glide plate translational support system;

FIG. 5 is a cross-sectional view of the nonremovable upper glide plate and translational support system;

FIG. 5A is a cross-sectional view of the nonremovable upper glide plate and an alternative embodiment of the translational support system;

FIG. 5B is a cross-sectional view of the nonremovable upper glide plate and a second alternative embodiment of the translational support system;

FIG. 5C is a schematic view of the upper glide plate at the high limit position;

FIG. 5D is a schematic view of the upper glide plate at an intermediate position;

FIG. 5E is a schematic view of the upper glide plate at the low limit position.

FIG. 6 is a schematic view of the standard glide plate food slicer configuration showing the slicing of the food items;

FIG. 7 is a schematic view of the standard glide plate food slicer configuration showing the return of the sliced food items to its original position;

FIG. 8 is a schematic view of the food slicer glide plate showing the slicing of a food item;

FIG. 9 is a schematic view of the food slicer glide plate showing the return of the sliced food item to its original position;

### DETAILED DESCRIPTION

The current embodiment of mandolin food slicers has been developed for general use in producing large quantities of sliced or shredded foods during preparation in the culinary arts. Many times, these food slicers are found in commercial kitchens or in use by caterers or chefs. The food slicers can enable the chef or caterer to produce a large quantity of, for example, shredded cheese or other garnishment type foods.

Food slicers are generally provided with a frame member which has parallel longitudinal side rails as well as intermediate glide plates between the side rails. The frame member usually has a handle at the forward end and a foot portion at the base end. Towards the middle of the food slicer between upper and lower glide plates are the vertical and/or horizontal cutting blades which enable the chef or caterer to prepare the food to the desired proportions. Also, usually provided is a hand guard which rides above the glide plates and is utilized to fix the food so that the chef can move the food over the horizontal and vertical plates without cutting his or her hand.

The caterer or chef will attach or fix the food to be sliced onto the hand guard, and then apply the food on top of the glide plates and move the food longitudinally back and forth over the horizontal and vertical blades. The food will drop below the cutting zone and fall onto a collection surface of some sort.

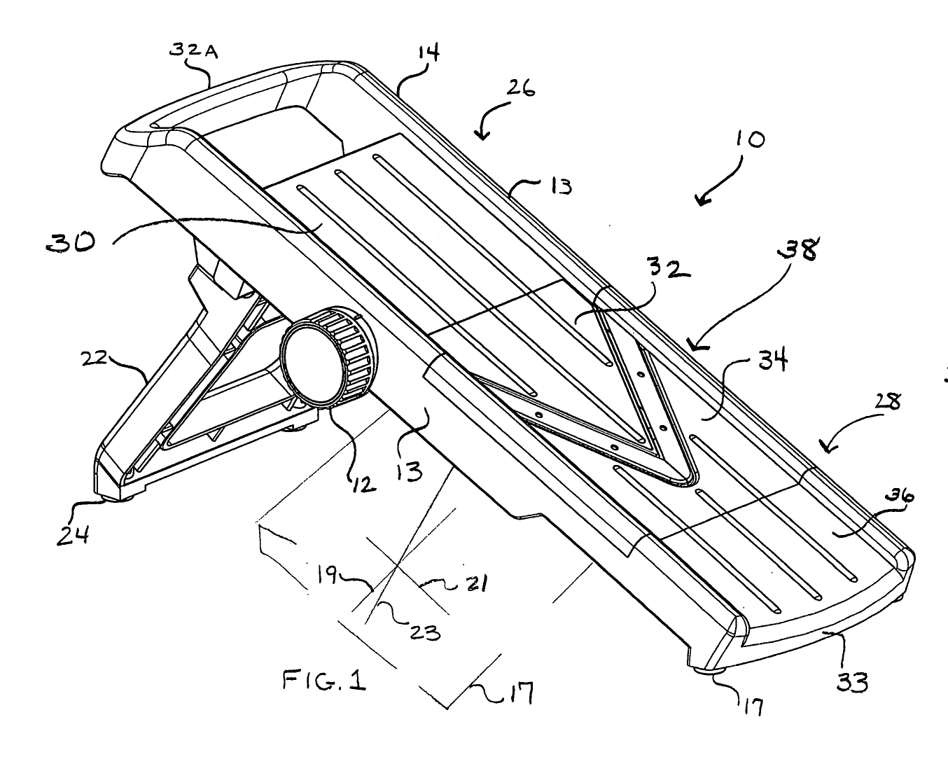

As indicated above, the food slicer 10, as discussed in FIG. 1, is comprised of a rectilinear frame or support frame 14 which has identical parallel but opposingly opposite side rails 13 which provide the majority of the frame structure. To complete the connection between the two parallel side rails, the frame is transversely connected by an upper portion which in the current embodiment comprises a handle portion 32 and a lower portion or rear end 33 which is part of the glide plate, which will be discussed below. The upper transversely connecting portion 32 is longitudinally forward and is supported by an upper leg support 22.

When in use, the food slicer 10, as seen in FIG. 1, is generally propped as a positive angle from the horizontal plane of the food preparation surface such as a countertop. The angle varies depending on the length of the food slicer upper leg section 22. When not in use, the food slicer upper leg 22 can be folded underneath the base portion of the mandolin or food slicing unit 10 for ease of storage.

The chef or caterer will adjust the food to the inclined angle of the glide plate arranged parallel or substantially parallel with the side rails 13 propped at the leg angle. The chef will then adjust the cutting thickness of the mandolin or food slicer 10.

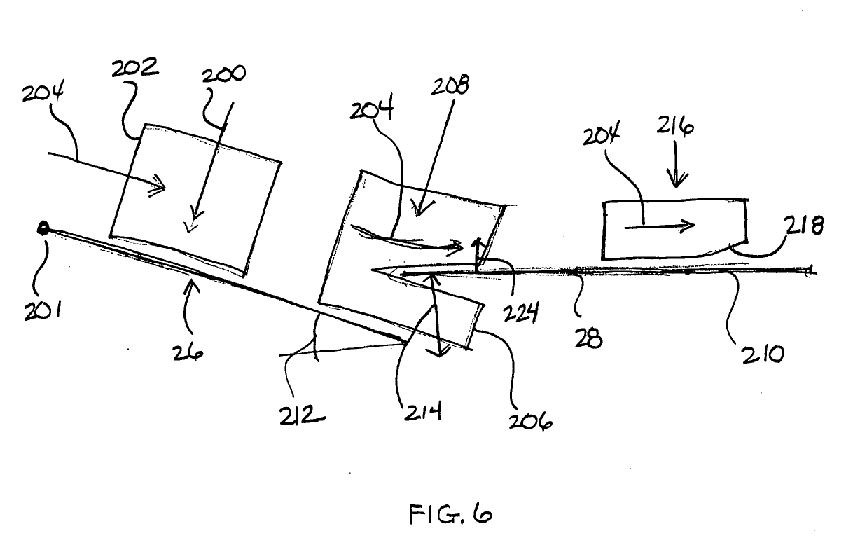

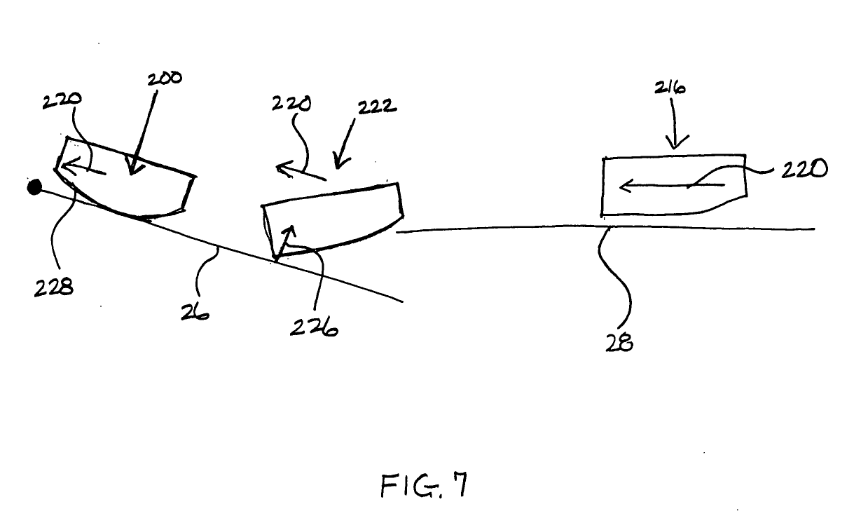

Generally speaking, most mandolins in the industry have an upper glide plate adjustment which places the upper glide plate at a nonparallel angle with the side rails 13. To discuss the arrangement and operation of these food slicers, a brief description of the food slicing mechanics of mandolins currently found on the market and as seen in FIG. 6 and 7 will be provided.

First referring to FIG. 6, the upper glide plate 26 has a pivot hinge 201 which is fixed rotatable about the hinge axis. At the transversal cutting slot 214 edge of the upper glide plate 26, the glide plate is free to move vertically upwards and/or downwards to adjust for the food slice cutting thickness. The lower glide plate 28 is generally fixed in a secured position parallel with the side rails. The chef places the food item 202 at the forward portion of the upper glide plate 26. He then fixes the food using in some cases a hand guard which is not shown, and applies a compressive force 200 normal to the upper glide plate. The chef then applies a longitudinal translational force 204 to drag the food item 202 towards the transverse cutting slot 214. The food item 202 is dragged across the transverse cutting slot 214 and a cut or sliced portion of the food item 206 falls through the transverse cutting slot 214. The chef continues to apply a compressive force which must be transferred from the normal direction to the upper glide plate to a normal direction perpendicular to the lower glide plate. This transitional force 208 has a transitional resultant force 224. The transitional resultant force 224 acts at the rearward edge of the food item and tends to create localized pressure thus compressing the food item and deforming it somewhat. The chef then continues with the transitional force 204 and the now compressive force normal to the lower glide plate 216. Upon retum, the chef will apply a return longitudinal force 220 and the same normalized compressive force 216 to the lower glide plate. When transitioning from the lower glide plate 28 to the upper guide plate 26, the chef will have to make an angular adjustment to the food item to make it parallel again with the upper glide plate. This adjustment may result in damage to the food item by localized pressure from a resultant transitioning compressive force 226 acting at the forward edge of the food item 202. Upon return to its original position, the food item now has been damaged by the transition forces due to the localized pressure at the food item edges.

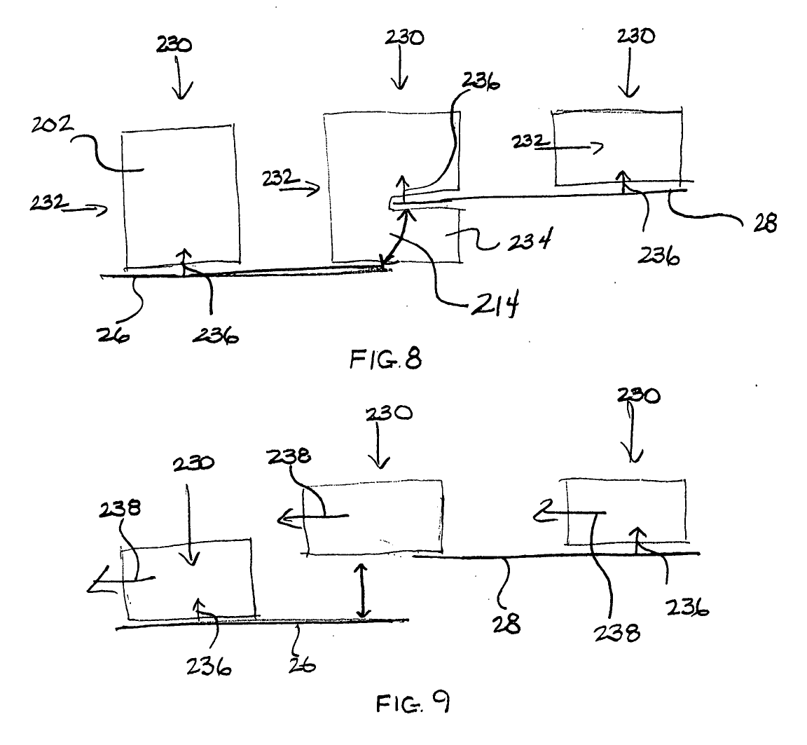

In the current embodiment, the upper glide plate 26 and the lower glide plate 28 are kept parallel with the side rails 13 as seen in FIGS. 8 and 9. The chef or caterer thus has only to apply a single normal compressive force 230 in the vertical direction perpendicular with the glide plate surfaces. Thus the compressive force is spread over the entire base of the food item 202 thus providing for a greater distribution of pressure and less chance of deformation of the food item. This is in keeping with studied distribution of force over a larger surface area which decreases the localized unit over pressure.

Briefly discussing the operational mechanics of utilizing a parallel guide plate system, the chef will apply a normal guide plate compressive force 230 to the food item 202. Concurrently, a longitudinal translational force 232 will be applied to translate the food item 202 from the upper or forward location to the lower or rearward location. As the food item as seen in FIG. 8 passes over the transverse cutting slot 214, the sliced or cut portion 234 drops away. The resultant 236 against the compressive force 230 stays relatively the same during this transitionary cutting action. The chef will then, as seen in FIG. 9, transfer the food item 202 back to its original upper location for another cutting operation. During this return, the compressive force 230 is kept perpendicular to the lower glide plate 28 and the upper glide plate 26. The chef transfers the food item over the forward edge of the lower glide plate and the food item will drop the cutting distance 214 down towards the upper glide plate 26. If the transition is accomplished quickly enough, the food item will drop onto the glide plate with a uniform landing thus providing an even landing pressure and a normalized distribution force parallel with the upper glide plate 26. This even distribution of landing pressure provides for less or minimal deformation of the food item 202 with little or no deformation depending on how much compressive force 230 is applied during the translational longitudinal return.

A more general discussion of the current embodiment of the food slicer 10 will now be provided. Referring to FIG. 1, the current food slicer 10 utilizes an upper glide plate 26 which is positioned at the forward portion of the food slicer. The food slicer 10 also has a lower glide plate 28 which is positioned at the rearward end of the food slicer. The upper glide plate in the current embodiment divided into two main plate sections. The first is a nonremovable upper glide plate section 30 and the second is a removable upper glide plate 32. Similarly, the lower glide plate section 28 is separated into two plate sections. The lower glide plate has a nonremovable lower glide plate section 36 and a removable lower glide plate section 34. The removable lower glide plate section 34 is positioned forward of the nonremovable lower glide plate 36. Positioned approximately midpoint of the food slicer slide side rails 13 is the blade or cutting assembly 38. The blade or cutting assembly is generally made of various horizontal and vertical blades which provide for slicing and dicing of the food item. In the current embodiment, the vertical blades are attached to the top face of the removable upper glide plate 32. The horizontal blades are arranged in the longitudinal and transverse planes and are connected to the forwardmost edge of the removable lower glide plate 34.

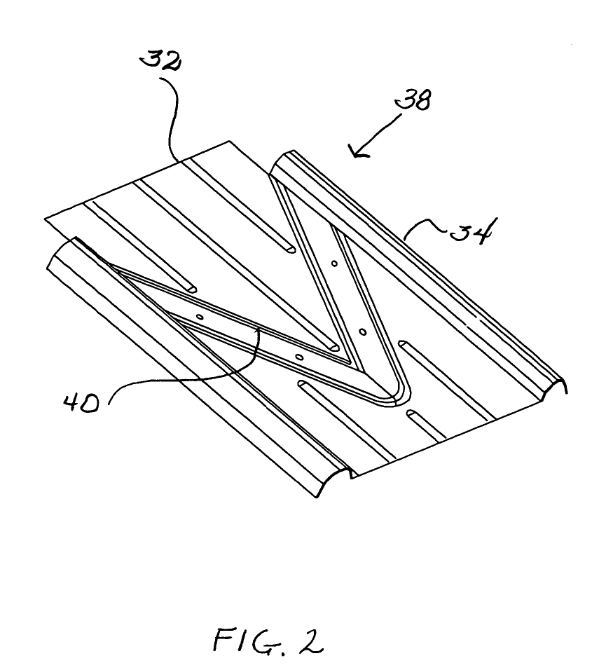

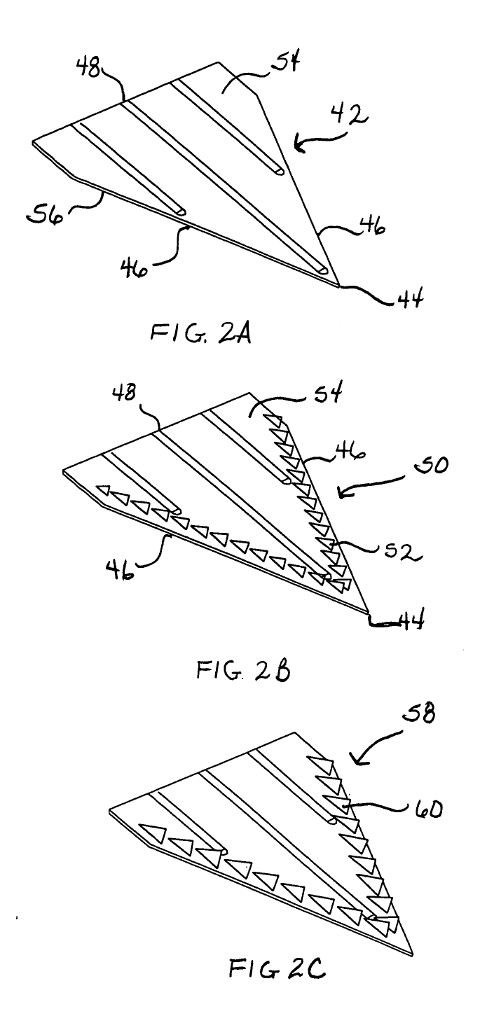

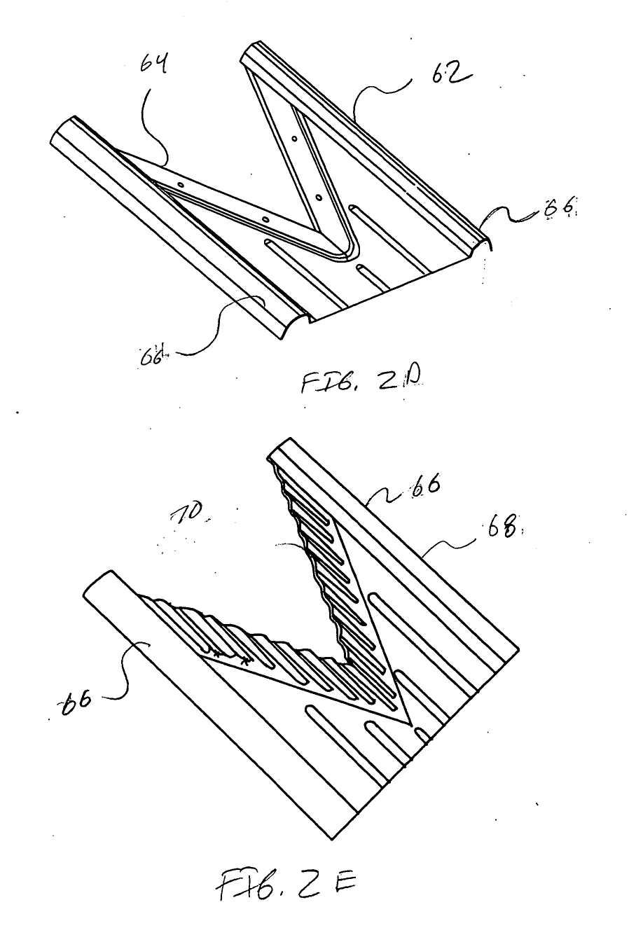

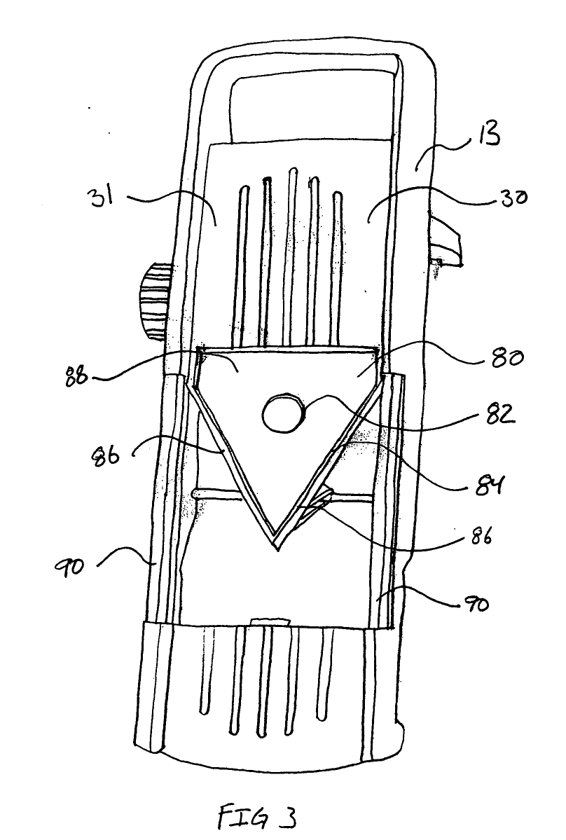

Referring to FIG. 2, the blade or cutting assembly 38 is shown separated from the main body of the food slicer 10. As previously mentioned, the removable upper glide plate 32 is positioned forward of the removable lower glide plate 34. At the general intersection or meeting of the removable upper glide plate rear edge and the removable lower glide plate forward or front edge is the cutting slot 40. The adjustment of the cutting slot 40 in the current embodiment is provided by moving the upper glide plate 26 in either a The adjustment of the cutting slot 40 in the current embodiment will be discussed further in detail below. Generally speaking, the cutting slot can be opened and closed in both the vertical direction as well as the longitudinal direction. In the current embodiment this is performed by moving the upper guide plate in the vertical and/or longitudinal direction. The upper guide plate as seen in FIG. 1 occupies a plane which is generally defined by the longitudinal axis and the transverse axis. The plane is allowed to move at least in the vertical and longitudinal directions with movement in the correct embodiment restricted to the transverse direction.

Referring back to discussion of the configuration of the removable upper guide plate 32, and referring to FIG. 2A, the removable upper guide plate as seen in FIG. 2A is shown having a flat guide plane or plate 42. In the current embodiment this upper guide plate movable portion is configured in somewhat of an A-frame type of configuration. The plate has an apex 44, and two legs 46, which form the frame of the “A” configuration. The shape also has a base 48 and the plate has a top face 54 and a bottom face 56.

The chef or caterer may wish to prepare food items which are cut in the horizontal direction as well as the vertical direction. Referring to FIG. 2B, to provide for the slicing, the guide plate removable portion is provided in a removable upper guide plate with small vertical slicing teeth 50. The small vertical slicing teeth 52 are configured in somewhat of a V-shape and placed linearly to parallel the edge or leg portion 46 of the plate configuration.

An additional embodiment as seen in FIG. 2C is provided with larger vertical slicing teeth 60 and allows for a wider food slicing preparation such as what would be seen with for example French fries or carrot sticks and the like.

This V-slicing configuration is also used in the removable lower guide plate with the horizontal slicing blade 62 is seen in FIG. 2D. The horizontal slicing blade 64 is positioned at the forward edge of the removable lower guide plate 62 and the forward edge is configured to parallel the A-frame configuration of the upper guide plate 32 as seen in FIGS. 2-2C. The blade configuration of the horizontal slicing blade 64 can be provided in different fashions for different food preparation results. One example is to provide a straight cutting blade edge as seen in FIG. 2D for the horizontal slicing blade 64, also providing a wave form edge result which produces a horizontal shredding slicing blade 70 as seen in FIG. 2E.

Although the upper guide plate has a removable portion, the structure is needed to contain the removable portion during operation. The removable upper guide plate 32 can be considered the male portion to the female removable upper glide plate recess 80 as seen in FIG. 3. This recess 80 provides for a temporary staging location for the guide plate removable portions and allows for interchangeability through in one form, providing a punch hole 82 which is an open recess or open hole in the center portion of the recess base 88 of the upper glide plate nonremovable portion 30.

The removable upper glide plate recess 80 is positioned within the nonremovable upper glide plate 30. The nonremovable upper glide plate 30 has a top surface 31 which is parallel with the top face 54 is seen in FIG. 2A of the removable upper glide plate 32 when installed in the recess 80. The recess has a recess base 88 as previously discussed, recess sidewalls 86 which parallel the legs 46 of the plate edge as seen in FIG. 2A, and the entire nonremovable upper glide plate 30 rests on a lower transverse axle system which will be discussed further below.

Similarly speaking, the removable lower glide plate 34 as seen in FIG. 2A has longitudinally aligned cylindrical plate arms 66 which drape over the side rail 13 as seen in FIG. 3 of the food slicer 10. The semicylindrical plate arms 66, FIG. 2D, fit within a removable lower glide plate recess 90 as seen in FIG. 3, which is substantially the same depth as the thickness of the cylindrical plate arms 66.

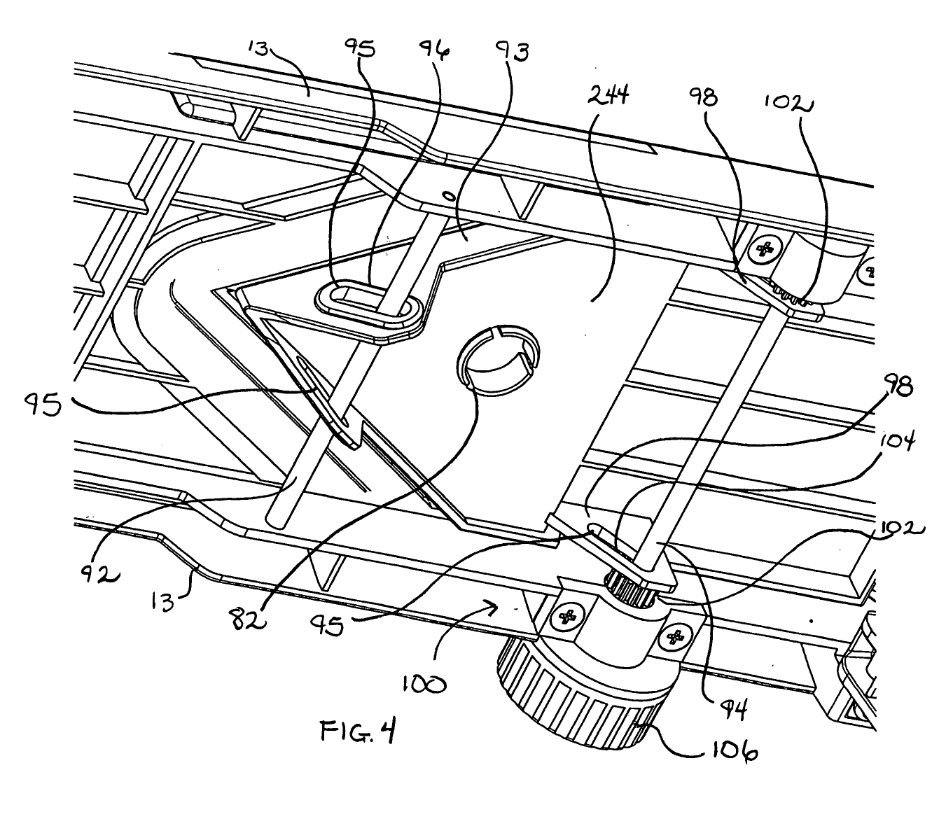

To keep the upper glide plate 26 in its longitudinal and transverse plane while still allowing for adjustment of the vertical slot 40, a translational adjustment system is provided. This translational adjustment system can take many forms; the current embodiment utilizes a rack and pinion system 100 as seen in FIG. 4. Additionally, a four bar linkage system, a simple incline, a simple lever system, a pulley system, a screw drive, a belt drive, and other translational systems which allow for movement of a plane orientated in the longitudinal and transverse directions to be moved translationally at least in the vertical and longitudinal directions.

The current embodiment provides one form of this translational adjustment system. Referring to FIG. 4, the nonremovable upper guide plate 30 is supported by two support axles. For additional vertical support, an incline stay 128 is provided so that the nonremovable upper glide plate 30, FIG. 4, has a three-part support base. This tripartite support base allows for a stable base although a dual support base would be equally as effective. The transverse axles include a lower transverse cylindrical shaft 92 which is fixed substantially in the rotational direction and spans between the side rails 13. Longitudinally forward of this lower transverse axle 92 is an upper transverse axle shaft 94 which is fixed in the longitudinal, vertical, and transverse directions but is allowed to rotate about 360° of freedom of its transversely aligned shaft axis.

In the current embodiment, the rack and pinion system 100 is attached to this rotationally free upper transverse axle shaft 94. Attached to one end of the axle shaft 94 is a gear knob 106 which allows for the user to rotate the axle shaft 94 to any rotational degree of freedom. The rack and pinion system 100 is made of two main components, the sprocket or gear or in other words pinion 102 which is rotatably fixed to the axle shaft 94. This pinion 102 is positioned to be interoperable with a rack or ladder which is essentially a flat bar running a linear distance with projecting vertical teeth. The rack 104 is attached in some form to the bottom edge of the upper guide plate 30. In the current embodiment, the upper guide plate 30 has a perimeter edge frame 93. The perimeter or edge frame 93 provides for additional rigidity of the guide plate and also has lower and upper guide frame projections which extend to interface with the axles.

The perimeter edge frame 93 has a lower guide frame 96 which substantially parallels the outer leg edge 86 as seen in FIG. 3 of the removable plate recess 80. The lower guide frame 96 projects vertically downwards to form a connection with the lower transverse shaft axle 92. Formed within the lower guide frame 96 are translationally aligned elliptical or semi cylindrical guide holes 95. Each guide hole allows for translational movement along the desired translational path of the guide plate while riding on the shaft or axle 92. Similarly, the perimeter edge frame 93 has an upper guide frame 98. This upper guide frame 98 has positioned within it the same translationally aligned cylindrical guide holes 95. Aligned in parallel with these translationally aligned cylindrical guide holes 95 is the rack 104 as previously discussed. The rack is permanently affixed to the outer edge of the upper guide frame 98. The upper guide frame 98 is essentially two legs which both parallel the vertical depth of the side rails 13. At each end of the upper transverse axle shaft, as previously discussed, is position the pinion 102 which is rotationally fixed to the transverse axle 94; each pinion is placed in operation with each rack attached to the upper guide frame legs 98.

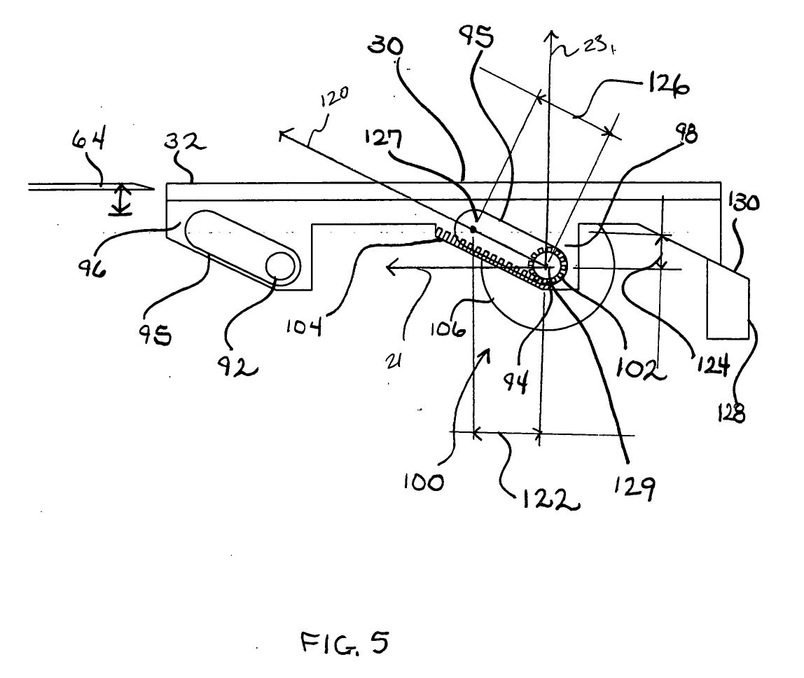

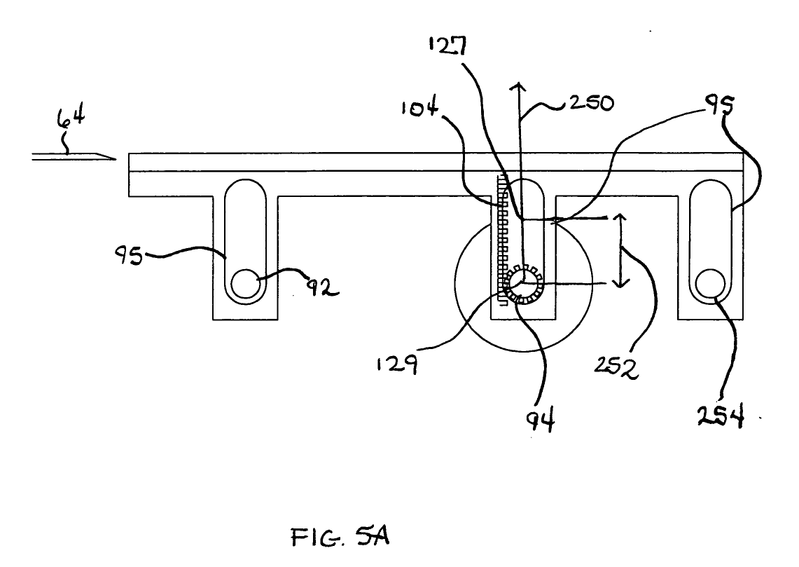

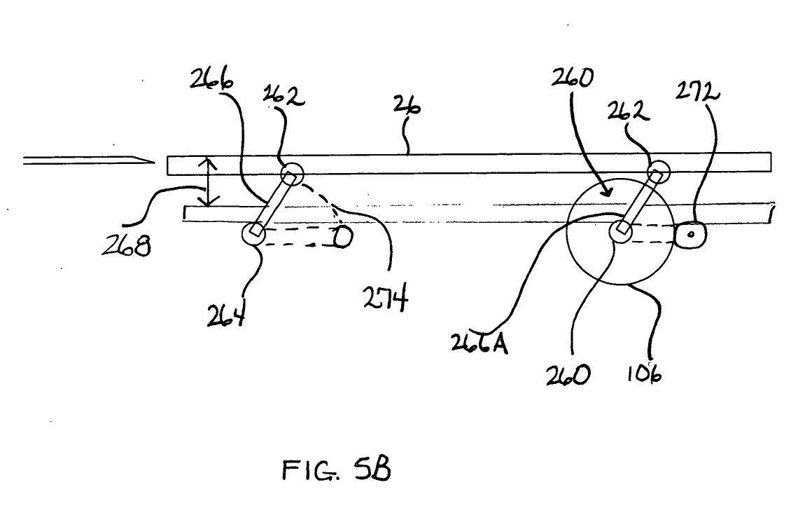

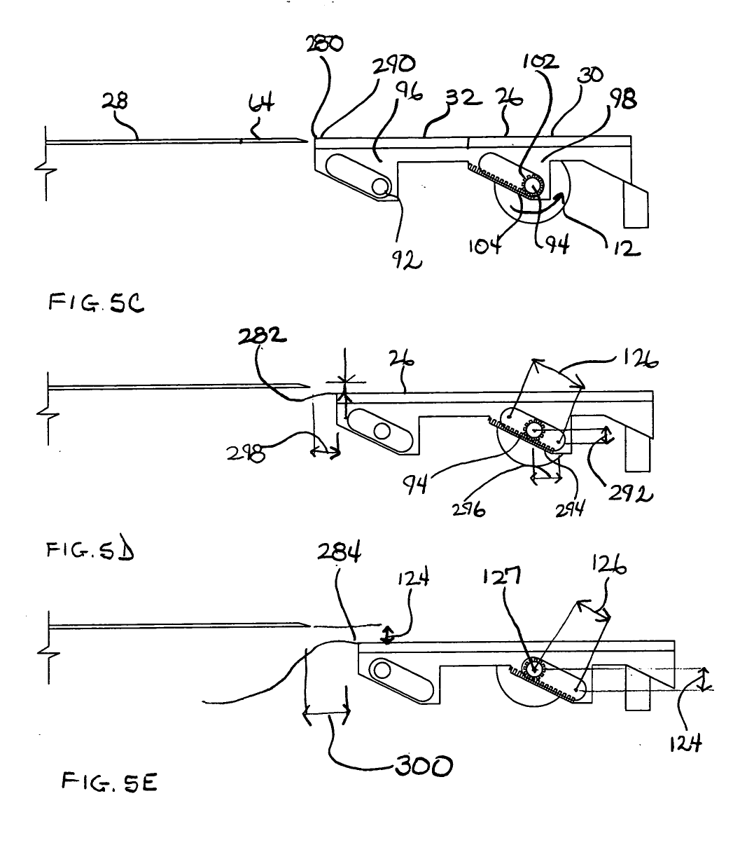

In the current embodiment the translation of the upper guide plate is determined by the orientation of the cylindrical guide holes 95 positioned within the upper and lower guide frame portions. Referring to FIG. 5, the cylindrical guide holes 95 have an incline path axis 120, which is along the path of the desired translational movement of the upper glide plate 26. This incline path axis 120 is at a positive angle away from the longitudinal axis 21 and arranged between the longitudinal axis 21 and the vertical axis 23. Consequently, the incline path axis 120 has a vertical travel range component 124 as well as a longitudinal travel range component 122. The incline path axis 120 is defined by the resultant of the horizontal and vertical ranges which are combined to give the incline travel range 126. The incline travel range is from a low upper glide plate limit position 127 to a high upper glide plate limit position 129.

When the upper transverse axle shaft 94 has its central axis positioned at the high upper glide plate limit position 129, the center of axis is at the lowest slot position within the cylindrical guide hole 95. Similarly, when the upper transverse axle shaft 94 has its center axis positioned at the low upper glide plate limit position 127, the center axis is at the highest position within the cylindrical guide hole 95.

While the translation of the upper guide plate is provided along an incline travel range 126 which follows an incline path axis 120 which also has arranged along the same parallel path the rack 104 attached to the upper guide frame 98 and each of the guide frame legs, the orientation of the cylindrical guide holes 95 can be provided so that for example as seen in FIG. 5A, the translation of the guide plate follows essentially a vertical travel path 250. The rack 104 remains parallel to the vertical travel path 250 and the cylindrical guide hole 95 is arranged along the vertical travel path 250 as well. Thus a vertical travel range 252 allows for an upper and lower travel range limit similar to the incline travel range limit 126 as previously discussed.

While the translation of the upper guide plate is provided along an incline travel range 126 which follows the inclined path axis 120, and which also provides for an arrangement of the rack 104 attached to the guide frame legs 98, the orientation of the cylindrical guide holes 95 can be provided in other angular arrangements. These can include a vertical arrangement as seen in FIG. 5A or other angular vertical path orientations which center around the origin of the upper transverse axle shaft 94. It is conceivable that the orientation of the cylindrical guide hole 95 can even take on somewhat of a curved profile shape providing desired logarithmic incline and decline travel paths as needed by the food preparation professional.

In addition to using a rack and pinion configuration 100 as seen in FIG. 5, an alternative embodiment for moving the upper guide plate 26 between an upper position and a lower position can include the use of a four bar linkage system 260 as seen in FIG. 5B. Mechanically speaking, the four bar linkage system utilizes at least two simple pivot pins which act as shafts. In the current embodiment they include a lower or rear pivot shaft 264 and an upper or forward pivot shaft 270.

At each end of the pivot shaft is located a rigid bar which acts as a link providing for the travel distance between the upper location and the lower location as previously mentioned above. In the current alternative embodiment, there are two forms of bars, a simply connected link bar 266 and a moment resisting link bar 266A. The simple connection bars 266 provide for 360 degree rotational degrees of freedom about the simple pivot pin 264 at the lower location and the simple upper pivot pin 270. Connected at one distil end into the upper simple pivot shaft 270 is the gear knob 106. Connected at the same distal end, is the rigid or moment resisting linkage bar 266. This bar is rigidly connected to the pivot At each end of the pivot shaft is located a rigid bar which acts as a link providing for the travel distance between the upper location and the lower location as previously mentioned above. In the current alternative embodiment, there are two forms of bars, a simply connected link bar t shaft 270 acting as a cantilever and rotating rigidly along the same axis of rotation as the gear knob 106 and the shaft 270. At the opposing end of the rigid connection of the link bar 266, the bar is simply connected to the bottom face of the glide plate or guide plate 26 as a simple pivot connection 262. This allows for the upper glide plate 26 to be simply supported in the vertical direction. The upper glide plate 26 also has the vertical and longitudinal degrees in freedom for adjustment in cutting thicknesses.

As previously discussed, the overall goal is to keep the upper glide plate 26 in a plane which stays parallel with the side rails 13 and the transverse axis and can move at least longitudinally and vertically in either direction. Rotation of the gear knob 106 is resisted in some form by a frictional resistance component 272 which in one form might be a low gear, a belt system or even a ridge and valley system within the gear knob 106 itself. No matter how the resistance is provided, the gear knob can rotate the upper pin shaft 270 which then rotates the four bar linkage system 260 allowing the upper guide plate 26 to travel along a semicircular travel path 274 and limited only by the physical restraints of the linkage system.

Now discussing the operation of the current embodiment, referring to FIG. 5C, the upper guide plate 26 is positioned at the high points 280 where the upper guide plate 26 is parallel and in an even plane with the lower guide plate 28. Thus, there is negligible vertical differential between the upper guide plate or the horizontal slicing blade 64 and the upper guide plate rear edge 290. The food preparation professional can rotate in this current embodiment the gear knob 12 counterclockwise and position the upper guide plate 26 to an intermediate cutting position as seen in FIG. 5D. The rotation of the gear knob 12 rotates the upper transverse axle shaft 94 which in turn concurrently rotates the gear or pinion 102. The pinion teeth interface and leverage the rack 104 and the upper guide plate ratchets downward the vertical travel distance 292 to the desired intermediate cutting position 294 of the upper transverse axle shaft 94. The vertical travel distance 292 during this intermediate position is directly proportional to the vertical cutting differential 282 at that intermediate location. Since the upper guide plate 26 is traveling along an angle, the longitudinal resultant distance or travel distance 296 concurrent to the vertical distance 292 is directly proportional to the longitudinal food slice gap 298 at the intermediate location.

After the food preparation professional has finished cutting at the desired intermediate food thickness and Referring to FIG. 5E, he can then rotate the gear knob 12 counterclockwise to drop the upper guide plate 26 to its lowest vertical differential or lowest vertical position 284 and greatest longitudinal position 300 from the horizontal slicing blade edge 64. Concurrently, the pinion has ratcheted the rack 104 to its highest vertical position 127 or in other words the lowest upper glide plate limit position 127 (as seen in FIG. 5). This also corresponds to the lower limit of the vertical travel range 124.

Thus the food preparation professional can ratchet and move the upper glide plate to any position between the high point of the rack incline and the low point of the rack incline and create varying food slice thicknesses with ease of food translational efficiency across the cutting slot and transitioning from the upper guide plate to the lower guide plate which remain substantially parallel throughout.

1. An apparatus to accomplish variable slicing of food items, the apparatus comprising:
a. a platform section arranged between two parallel side rails, said platform section having a longitudinal axis, a vertical axis, a transverse axis, a front end, and a rear end, said platform section further comprising:
i. a forward portion and a rearward portion, the forward portion having a rear edge, the rearward portion having a front edge, said forward portion substantially aligned within a forward portion plane, said forward portion plane aligned in parallel with said longitudinal axis and said transverse axis, said forward portion movable along at least said longitudinal axial direction and said vertical axial direction and between an upper location and a lower location, said rear edge and said front edge defining a transversely aligned slot;
ii. a positioning section arranged along a translational path, said positioning section configured to move said forward portion along said translational path and between said upper and lower locations;
b. whereby operating said positioning section moves said forward portion between said upper location and said lower location and creates a transversely aligned slot between said rear edge and said front edge of lesser or greater distance respectively.

2. The apparatus according to claim 1 wherein said positioning section is further comprised of a rack and pinion gear system, said rack substantially aligned proximate to said translational path and affixed to said forward portion, said pinion interoperably engaging said rack and connected to a transversely aligned rotational shaft which provides for longitudinal and vertical support of said forward portion.

3. The apparatus according to claim 1 wherein said positioning section is further comprised of a four-bar linkage system, said four-bar linkage system comprising a first and second transverse axle shaft, four linkage bars, at least one of said linkage bars rigidly connected to first or second transverse axle shaft, a control knob rigidly connected to first or second transverse axle shaft having said rigidly connected linkage bar, said linkage bars pivotally connected to said forward portion.

4. The apparatus according to claim 1 wherein said forward portion is substantially configured in a trapezoidal configuration, said trapezoidal configuration having a rectilinear upper portion and a substantially triangular lower portion, said rectilinear upper portion having a top guide plate, said triangular lower portion comprised of a guide plate recess and a removable guide plate, where said removable guide plate has a top surface flush with said rectilinear upper portion top guide plate when said removable guide plate is contained within said guide plate recess.

5. The apparatus according to claim 4 wherein said removable forward portion guide plate is further comprised of small vertically aligned julienne blades wherein said small julienne blades are closely spaced along the edges of said triangular lower portion removable plate.

6. The apparatus according to claim 4 wherein said removable forward portion guide plate is further comprised of large vertically aligned julienne blades wherein said large julienne blades are distantly spaced along the edge of said triangular lower portion removable plate.

7. The apparatus according to claim 2 wherein said rearward portion is substantially configured in a trapezoidal configuration, said trapezoidal configuration having a rectilinear lower portion and a removable trapezoidal upper portion, said rectilinear lower portion having a top guide plate, said removable trapezoidal upper portion configured to be positioned on said side rails within side rail recesses, where said removable trapezoidal upper portion has a top surface flush with said rectilinear lower portion and further includes a horizontally aligned slicing blade positioned at the forwardmost edge of said removable trapezoidal upper portion.

8. The apparatus according to claim 2 wherein said forward portion is further comprised of a top surface and a supporting frame, said supporting frame having translational guide slots, said translational guide slots following the direction of the translational path.

9. The apparatus according to claim 8 wherein said forward portion is further comprised of an interface between said translational guide slots and a first transversely aligned axle and a second transversely aligned axle, said first transversely aligned axle positioned rearward of said second transversely aligned axle, said first transversely aligned axle and said second transversely aligned axle spanning between said side rails.

10. The apparatus according to claim 9 wherein said first and second transversely aligned axles further comprise:
a. said first transversely aligned axle being fixed in the vertical, longitudinal, transverse, and rotational directions;
b. said second transversely aligned axle being fixed in the vertical, longitudinal, and transverse directions and allowed to rotate about its transverse axis.

11. The apparatus according to claim 9 wherein said second transversely aligned axle is rotationally fixed to a control knob.

12. The apparatus according to claim 1 wherein said translational path is further comprised of:
a. a linear translational path;
b. a curvilinear translational path;
c. a semicircular translational path;
d. a semielliptical translational path.

13. The apparatus according to claim 12 wherein said linear translational path is arranged in a positive angular direction from the longitudinal axis of not less than 15 deg.

14. The apparatus according to claim 12 wherein said linear translational path is arranged in a vertical direction.

15. The apparatus according to claim 12 wherein said curvilinear translational path has a logarithmic gradation.

16. The apparatus according to claim 12 wherein said semicircular translational path further comprises a range between:
a. 0° to 90°;
b. 0° to 180°;
c. 0° to −180°.

17. The apparatus according to claim 12 wherein said semielliptical translational path further comprises a range between:
a. 0° to 180°;
b. 0° to −180°.

18. An apparatus to accomplish variable slicing food items, the apparatus comprising:
a. a platform section arranged between two parallel side rails, said platform section having a longitudinal axis, vertical axis, transverse axis, a front end, and a rear end, said platform section further comprising:
b. a forward portion and a rearward portion, said forward portion having a rear edge, the rearward portion having a front edge, said forward portion substantially aligned in parallel with said longitudinal and transverse axes, said forward portion further comprising:
i. a top surface and a support frame, said support frame having translational guide slots, said translational guide slots interfacing with a first transversely aligned axle and a second transversely aligned axle, said first transversely aligned axle positioned rearward of said second transversely aligned axle,
ii. said translational guide slot following a translational path between an upper location and a lower location, said rear edge and said front edge defining a transversely aligned slot;
c. a positioning section arranged along said translational path, said positioning section comprising a rack and pinion assembly, said rack and pinion assembly comprising a rack portion and a pinion portion, said rack portion including one or more racks, each rack having a bar aligned with said translational path and having projecting teeth, said pinion portion including one or more pinions attached to said first or second transversely aligned axle and interoperably positioned with said corresponding rack, a control knob rotationally attached to said first or second transversely aligned axle to provide rotation to said attached pinion against said rack,
d. whereby rotating said pinion against said rack moves said translational guide slot of said forward portion along said translational path between said upper location and said lower location creating a transversely aligned slot of lesser or greater distance between said rear edge and said front edge.

19. An apparatus to accomplish variable slicing food items, the apparatus comprising:
a. a platform section arranged between two parallel side rails, said platform section having a longitudinal axis, vertical axis, transverse axis, a front end, and a rear end, said platform section further comprising:
b. a forward portion and a rearward portion, said forward portion having a rear edge, the rearward portion having a front edge, said forward portion substantially aligned in parallel with said longitudinal and transverse axes, said forward portion following a translational path between an upper location and a lower location, said rear edge and said front edge defining a transversely aligned slot;
c. a positioning section arranged along said translational path, said positioning section comprising a four-bar linkage system, said four-bar linkage system comprising a first and second transverse axle shaft, four linkage bars, at least one of said linkage bars rigidly connected to first or second transverse axle shaft, a control knob rigidly connected to first or second transverse axle shaft having said rigidly connected linkage bar, said linkage bars pivotally connected to said forward portion,
d. whereby rotating said control knob rotates said first or second transverse axle shaft rigidly connected to said linkage bar and moves said forward portion along said translational path between said upper location and said lower location creating a transversely aligned slot of lesser or greater distance between said rear edge and said front edge.

20. A method to provide variable slicing of food items, said method comprising:
a. utilizing a platform section having a longitudinal axis, a vertical axis, a transverse text, a front end, a rear end, said platform section further comprising a forward portion, a rearward portion, the forward portion having a rear edge, the rearward portion having a front edge, said forward portion aligned in parallel with said longitudinal axis and said transverse axis, said forward portion movable along a translational path and within at least said longitudinal axial direction and said vertical axial direction and between an upper location and a lower location, said rear edge and said front edge defining a transversely aligned slot,
b. operating a positioning section to move said forward portion along said translational path and between said upper location and said lower location, said positioning section having a rack and pinion gear system, said rack aligned along said translational path and affixed to said forward portion, said pinion interoperably engaging said rack and connected to a transversely aligned rotation shaft, said rotation shaft providing longitudinal and vertical support of said forward portion, moving said forward portion by:
c. rotating said rotation shaft;
d. rolling said pinion along said rack;
e. moving said forward portion along with said rack along said translational path and between said upper and lower locations;
f. moving said rear edge of said forward portion along said translational path and between said upper and lower locations;
g. increasing and decreasing the transversely aligned slot by moving said rear edge along said translational path between said upper and lower locations.
